(19) United States
(12) Patent Application Publication
(10) Pub. No.: US 2003/0054830 A1
(43) Pub. Date: Mar. 20, 2003

(54) Navigation system for mobile communication devices

(75) Inventors: Roland Williams, Pleasant Hill, CA (US); Todd G. Simpson, Calgary (CA)

Correspondence Address: LAW OFFICES OF JAMES D. IVEY, 3025 TOTTERDELL STREET, OAKLAND, CA, 94611-1742, US

(73) Assignee: Zi Corporation

(21) Appl. No.: 09/947,202

(22) Filed: Sep. 4, 2001

(51) Int. Cl. H04Q 7/20

(52) U.S. Cl. 455/456; 455/566

(57) ABSTRACT

A navigation assistance system provides navigational guidance to a user of a mobile appliance equipped with a radio transceiver. The user can specify a destination address either directly or categorically and select from any choices to resolve ambiguity. The user submits the selected destination to a fixed radio system such as a cellular telephony system which estimates the user position, determines the relative location of the destination and sends to the user appliance data which allows the display of approximate range and bearing to the destination. The mobile appliance can be equipped with a compass which can be electronic and which allows a user to be shown the direction of travel in order to reach the destination.

### FIELD OF THE INVENTION

This invention relates to the field of electronic navigation systems and mobile communications devices and, in particular, to navigation systems within mobile communication devices.

### BACKGROUND OF THE INVENTION

Navigation has existed as an art since the earliest days of human exploration. Techniques, though primitive, relied upon determination of position relative to visible landmarks and was confined to land areas for most of history. Navigation beyond sight of land was haphazard and until recent times barely practical until the invention of accurate chronometers. This history is detailed in David Sobel, Longitude, Econo-Clad Books; ISBN: 0613022203 (October 1999).

The discovery that a radio transmitter could be located relatively precisely was a landmark in air navigation in that such location allowed accurate courses to be flown. However, determining the position of the radio transmitter required the operator of transmitter location equipment—typically the pilot or navigator of an aircraft—to be rather sophisticated and to perform substantial work, involving calculation by the navigator to establish the interception point of two radials from different known radio stations. This method of triangulation is a well understood survey technique and a device known as a Radio Magnetic Indicator (RMI) displays the bearing from an aircraft or other vehicle to each of two selected radio beacons. By utilizing a movable compass card slaved to the heading of the vehicle, the operator could now determine, with the aid of a map, the position of the vehicle and its approximate direction of travel (heading) all from a single instrument. The arrival of distance measuring equipment (DME), which determined distance along a course by measuring the transit time of radio pulses, finally reduced the navigator's task to a relatively mechanical procedure. However, these devices were bulky, relied on accurately positioned radiating beacons and no small amount of map reading skill on the part of the user.

In recent years, Global Positioning Satellite (GPS) systems have put navigational abilities which were unimaginable just a couple decades ago into the hands of the average person at a very reasonable cost. GPS devices have been made sufficiently small and compact so as to fit on the wrist of a user much like a wrist watch.

Portable GPS devices are particularly helpful and therefore popular with people for whom navigation is very important. Such people include pilots, boat operators, and hikers for example. Some models of cars are currently being equipped with GPS navigation systems. However, the popularity of GPS devices is currently limited to people with special navigation needs or as part of a larger product such as a car in which the expense of a GPS device is dwarfed by, and can be included in, the expense of the larger product.

One significant reason for the limited popularity of GPS devices is that they require sophisticated, special-purpose circuitry to track numerous satellites and to cooperate with those numerous satellites to determine a relative position of a particular GPS device. Such special-purpose circuitry represents a generally affordable, yet significant cost.

A low-cost, easily portable alternative to currently available GPS devices for positioning information and personal navigation would bring personal electronic navigation to many more people.

### SUMMARY OF THE INVENTION

In accordance with the present invention, a mobile communications device such as a cellular telephone receives navigation data indicating a relative position of the mobile communications device to an intended destination to provide navigation assistance to the user of the mobile communications device. The mobile communications device requests such navigation data from a fixed base station in communication with the mobile communications device. In response to such a request, the base station determines the approximate geographical location of the mobile communications device in a conventional manner without reliance on external position awareness on the part of the mobile device. In addition, a bearing and range to the intended destination from the measured location of the mobile communications device is determined. The navigation data received by the mobile communications device can include the determined bearing and range. The navigation data can also include such things as latitude and longitude of the mobile communications device, map data, and progressive navigation instructions for example.

Further in accordance with the present invention, the mobile communications device includes a compass for enabling directional instructions to the user. In particular, the compass of the mobile communications device is used, in conjunction with the bearing to the intended destination, to determine a relative bearing to the intended destination. The relative bearing, thus determined, can be displayed as an arrow in the general direction of the intended destination relative to a directional orientation of the mobile communications device. The sampling of the compass of the mobile communications device can be performed sufficiently frequently to provide real-time and interactive navigation assistance to the user. For example, when the compass is sampled multiple times per second, the user can turn in either direction while holding the mobile communications device and the indicated relative bearing to the intended destination updates sufficiently frequently to provide useful guidance to the user while turning. Thus, the user is provided with a convenient and intuitive interface for determining the direction to the intended destination relative to the user's surroundings.

It should be appreciated that the relative bearing is determined relative to the orientation of the mobile communications device and not derived by rate of change of position as is done by GPS devices. Thus, while a GPS device does not accurately reflect heading of the GPS device while rotating about a single fixed location, a mobile communications device using an included compass in accordance with the present invention does.

It should be further appreciated that the range to the destination from the measured location of the mobile communications device can also be displayed to the user. However, the range to the destination as displayed to the user is generally not affected by the compass of the mobile communications device.

To determine a bearing and range to the intended destination, the location of the mobile communications device is determined. The location of the mobile communications device can be determined using, for example, the Cursor™ remote unit location system of Cambridge Positioning Systems of Cambridge, England, or a similar technology from Cel-Lok of Calgary, Alberta, Canada. Such location technologies are commercial service offerings designed to support the Federal Communications Commission's (FCC's) mandate that the locations of mobile telephones placing emergency calls shall be determined and that information regarding the location of such a mobile telephone shall be available to the responding emergency service.

Once the location of the mobile communications device is determined, the intended destination is compared to the location of the mobile communications device to determine the bearing and range from the mobile communications device to the intended destination.

As the user moves toward the destination, the location of the mobile communications device changes. Accordingly, the bearing and range to the intended destination is determined periodically. The frequency of such bearing and range periodic determinations can be less than the frequency of the relative bearing updates made by reference to the compass of the mobile communications device since the directional orientation of the mobile communications device typically changes more rapidly than does the location of the mobile communications device when held by a pedestrian user.

The frequency at which the location of the mobile communications device, and thus the bearing and range to the intended destination, is updated depends at least partly on the accuracy with which the location of the mobile communications device can be determined and the rate at which that location is likely to change. In addition, frequency of location updates can depend on the level of service desired by the user. In particular, by allowing modification of the period at which updates are made, the quality or grade of service offered can be adjusted to meet the willingness of the user to pay for different grades of service. During periods of heavy demand, decreasing the frequency of updates frees processing and communications bandwidth to serve a larger number of users of such a navigation service.

Thus, by making a relatively small change to mobile communications devices, namely, incorporating the ability to receive and display navigation data and including a small compass; such devices can be made to provide navigational guidance capability to users comparable to what is currently provided by relatively expensive GPS guidance systems.

### BRIEF DESCRIPTION OF THE DRAWINGS

FIG. 1 is a diagram showing a mobile communications device and base station which cooperate to provide navigation guidance to a user of the mobile communications device in accordance with the present invention.

FIG. 2 is a block diagram showing elements of the mobile communications device and base station of FIG. 1 in greater detail.

FIG. 3 is a logic flow diagram showing the navigation process of the mobile communications device in accordance with the present invention.

FIG. 4 is a logic flow diagram showing the navigation process of the base station in accordance with the present invention.

FIG. 5 is a display view showing an illustrative navigation display in accordance with the present invention.

FIG. 6 illustrates determination of bearing and range from the mobile communications device to the destination using Cartesian coordinates.

FIG. 7 illustrates determination of bearing and range from the mobile communications device to the destination using radial coordinates.

FIGS. 8 and 9 are display views of respective alternative embodiments.

### DETAILED DESCRIPTION

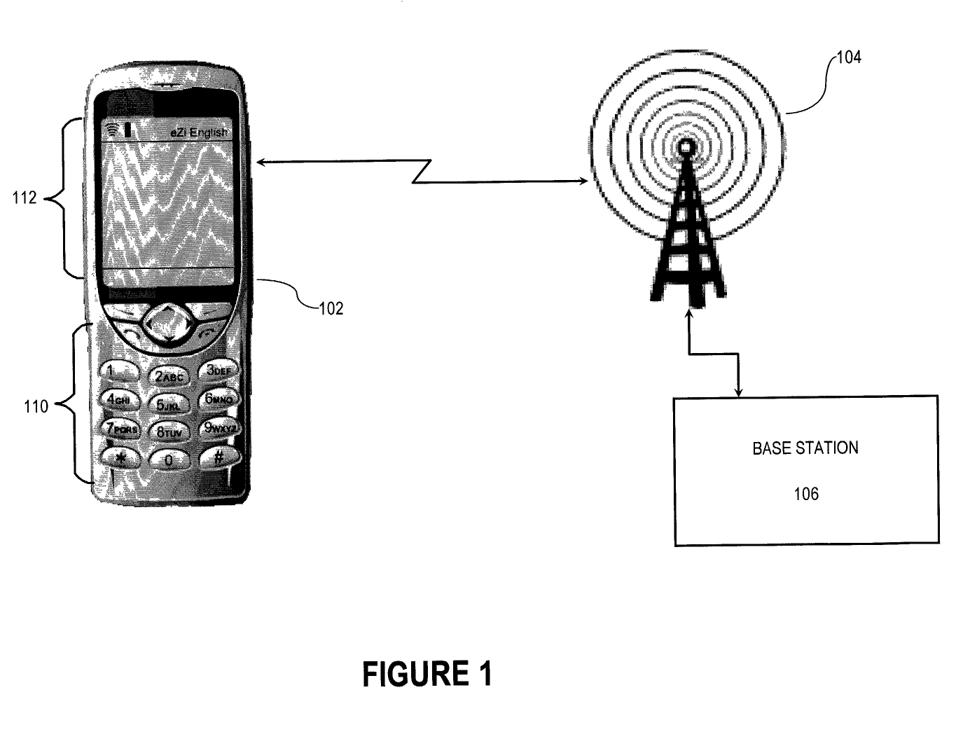

In accordance with the present invention, the location of a mobile communications device 102 (FIG. 1), which can be a cellular telephone for example, is determined by one or more base stations 106 and information about the determined location is communicated to mobile communications device 102 for representation to the user. In particular, the location is represented in this illustrative embodiment as a relative bearing and range to a destination. It should be appreciated that the destination can be a fixed location which is specified by an address or other location specification such as latitude/longitude coordinates or a mobile target such as other mobile communications devices.

FIG. 1 shows mobile communications device 102 which is in communication with a base station 106 through a fixed-location antenna 104. In the illustrative embodiment described herein, mobile communications device 102 is a cellular telephone. However, it is appreciated that mobile communications device 102 can be any of a number of other types of mobile communications devices including, without limitation, a two-way pager, a personal digital assistant (PDA) with communications capability, or a mobile modem such as the Ricochet™ mobile modem available from Metricom, Inc. of San Jose, Calif.—including or excluding an attached personal computer.

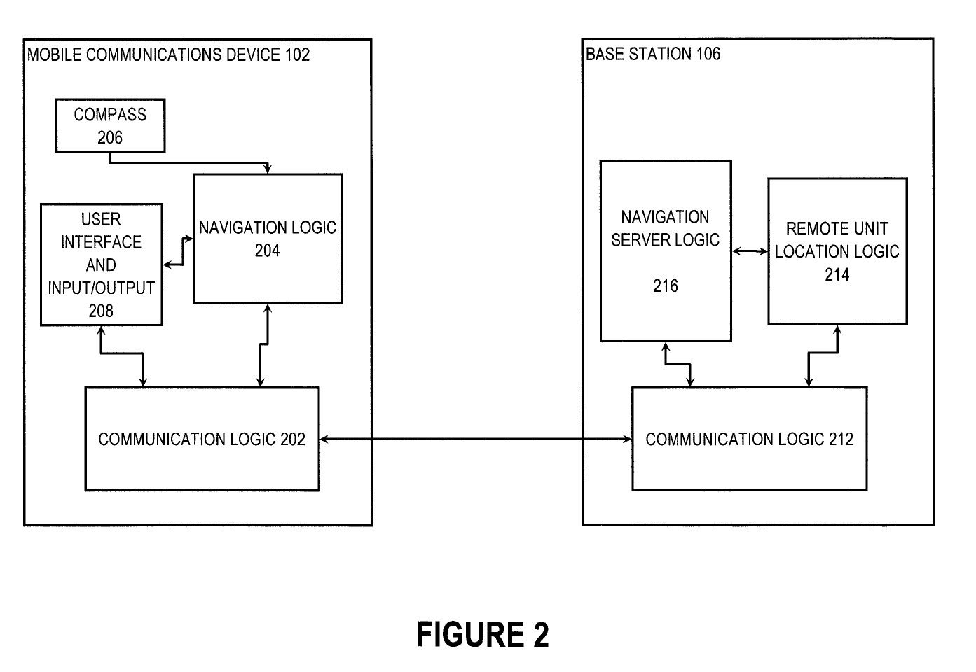

Mobile communications device 102 and base station 106, particularly elements which cooperate to assist navigation, are shown in greater detail in FIG. 2. Mobile communications device 102 includes communication logic 202 which cooperates with communication logic 212 of base station 106 to carry out voice communications in a conventional manner. In this illustrative embodiment, communication logic 202 and communication logic 212 cooperate to carry out mobile telephone communications in a manner which is conventional for cellular telephones and base stations. Such mobile telephone communications includes, for example, (i) channel changing or frequency hopping for spread-spectrum protocols, (ii) hand-offs to other base stations as mobile communications device 102 moves from the region of one base station to the region of another, (iii) control of transmit power of mobile communications device 102, (iv) full-duplex voice communication or common variants, and (iv) digital data communication according to any of a number of data communication protocols. Such data communication protocols include, for example, circuit-switched data services for Global System for Mobile Communications (GSM) networks, circuit-switched data service for CDMA networks, and Cellular Digital Packet Data (CDPD). Data messages exchanged between mobile communications device 102 and base station 106 as described below are exchanged according to such a data communications protocol. It should be appreciated and understood that any packet data structure and transmission protocol consistent with mobility can used to exchange such data messages between mobile communications device 102 and base station 106 including, without limitation, emerging standards for Wireless Area Networks such as IEEE 802.11x (currently IEEE 802.11b) and the Bluetooth defacto standard.

Mobile communications device 102 also includes user interface and input/output (I/O) logic 208. Mobile communications device 102 include a keypad 110 (FIG. 1), a display 112, and a speaker and microphone for normal voice communication. While a typical telephone-style keypad 110 is shown, it should be appreciated that generally any type of user input device can be used. For example, such user input devices include, without limitation, keypads with button layouts other than that shown in FIG. 1, touch-sensitive screens with either virtual keypads or hand-writing recognition, speech recognition circuitry and logic, and graphical user interface input devices. User interface and I/O logic 208 generates signals in response to physical manipulation of keypad 110 (FIG. 1) by the user and displays textual and/or graphical information to the user in display 112 and can also present auditory information through a speaker or headset jack to the user as well. User interface and I/O logic 208 (FIG. 2) and communication logic 202 combine to provide communications through mobile communications device 102 in a conventional manner.

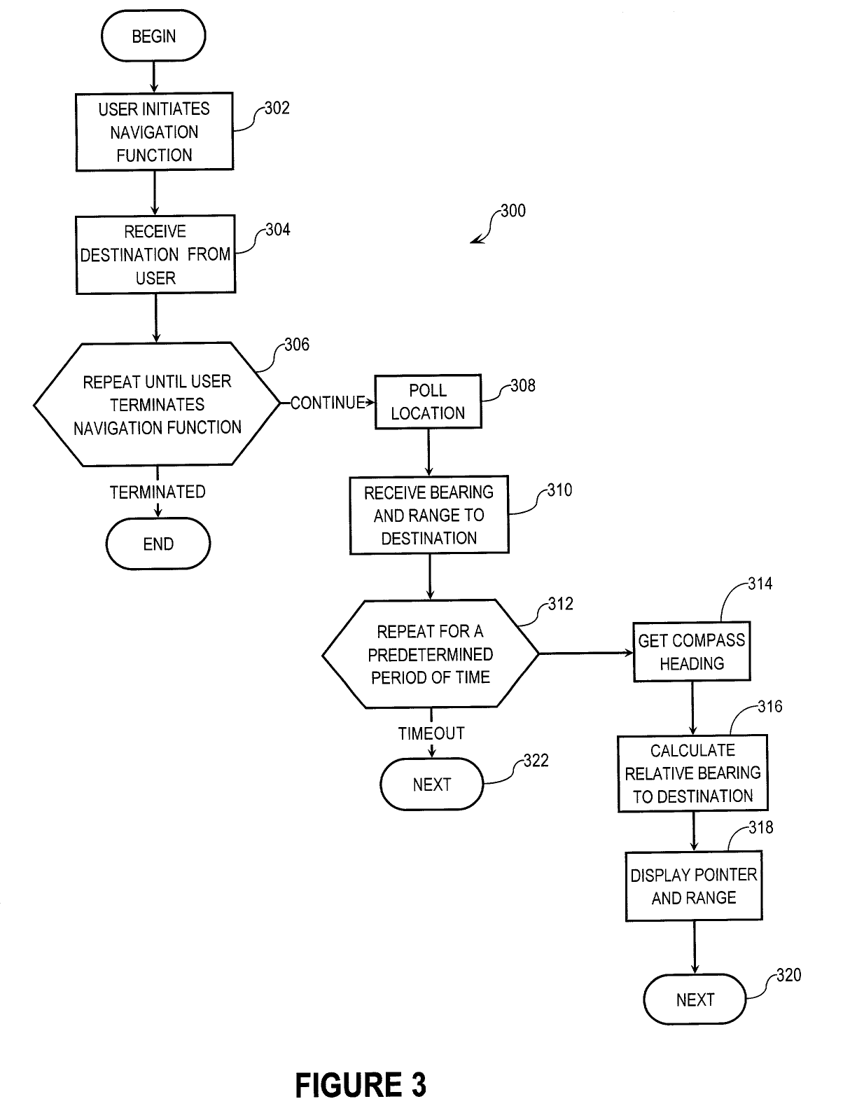

Mobile communications device 102 further includes navigation logic 204 which assists the user in navigating from a current, unknown location to a desired destination. The user initiates navigation processing by navigation logic 204 by pressing, for example, a dedicated button of keypad 110 (FIG. 1) or by traversing a user-interface menu using conventional user-interface techniques. Processing by navigation logic 204 in response is illustrated in logic flow diagram 300 (FIG. 3).

In step 302, navigation logic 204 initiates a navigation mode in response to the user's issued navigation command.

In step 304, navigation logic 204 receives data from the user specifying a destination to which the user would like to travel. The user can enter the destination in any of a number of ways. The user can enter numerical values representing latitudinal and longitudinal coordinates of the destination or generally any alphanumeric sequence identifying a destination or waypoint using keypad 110. The user can enter a street address using keypad 110 using a multi-tap technique for entering letters or using a predictive technique such as the predictive text entering technique known as the eZiText™ text entry system by Zi Corporation of Calgary, Alberta, Canada. Descriptions and demonstrations of the eZiText™ text entry system can be found at Zi Corporation's web site (http://www.zicorp.com). Briefly, a number of characters are mapped to each key of a limited keypad and key presses are disambiguated using predictive analysis. As a simple example, the typical telephone keypad associates the “2” key with the letters, “a,” “b,” and “c.” A single press of the “2” key can be interpreted as an “a,” a “b,” or a “c.” Pressing the “2” key twice can be the beginning of any of a number of words. For example, “cat,” “bat,” and “act” all begin with the “2-2” sequence. All such words are sorted according to predicted usage frequency and the user can select a predicted word at any time, thus reducing significantly the number of key presses required to specify various words.

Of course, it should be appreciated that entered text is not limited to the Latin/Roman alphabet. Ideographic languages, such as Chinese, can also be recognized as described in U.S. Pat. No. 5,109,352 to Robert O'Dell which is incorporated herein by reference.

If mobile communications device 102 has access to the World Wide Web and includes a browser (e.g., if mobile communications device 102 is a WAP-enabled cellular phone or a PDA with World Wide Web browsing capability), the destination address can be imported from a web-page viewed by the user. In addition, the user can cause selected addresses to be stored in a “favorites” list from which the user can select such a previously entered address in step 304. Furthermore, if the destination is a mobile target such as another mobile communications device, the destination can be specified by a code number such as a telephone number of the mobile target.

Logic which is used by the user to enter data identifying the destination can reside in navigation logic 204 or in navigation server logic 216 which cooperates with navigation logic 204 to provide the navigation assistance described herein. Navigation server logic 216 can, for example, assist in predictive interpretation of keypad buttons pressed by the user. In particular, navigation server logic 216 corresponds to a fixed base station 106 and therefore can limit street names to those of streets within a predetermined range of base station 106. In addition, navigation server logic 216 can provide a list of cities within a predetermined range of base station 106 such that the user can select a city from this list such that using a rather limited (in some embodiments) keypad 110 to enter an alphanumeric city name is obviated. Furthermore, upon selection of a destination region such as a city, navigation server logic 216 can retrieve a list of predetermined locations and associated data corresponding to the selected destination region.

After step 304 (FIG. 3), processing by navigation logic 204 (FIG. 2) transfers to loop step 306 which, in conjunction with next step 322, defines a loop in which steps 308-320 are repeated until the user terminates the navigation function using conventional user-interface techniques such as pressing or pressing and holding a dedicated button in keypad 110 for example.

In step 308, navigation logic 204 polls the location of mobile communications device 102. In particular, navigation logic 204 requests that remote unit location logic 214 determines the location of mobile communications device 102. In one embodiment, polling location in step 308 includes sending data identifying the destination entered by the user. In an alternative embodiment, navigation logic 204 and navigation server logic 216 cooperate to interpret user-generated signals representing the destination intended by the user in step 304. Accordingly, navigation server logic 216 knows the destination intended by the user, and no such destination data is included in the location poll of step 308 in this alternative embodiment.

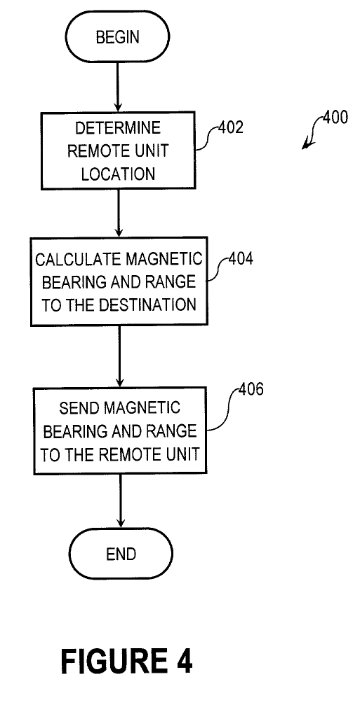

In response to the location poll of step 308, navigation server logic 216 acts as shown in logic flow diagram 400 (FIG. 4). In step 402, navigation server logic 216 (FIG. 2) initiates determination of a geographical location of mobile communications device 102 through remote unit location logic 214. In this illustrative embodiment, remote unit location logic 214 is the Cursor™ remote unit location system of Cambridge Positioning Systems of Cambridge, England. The Cursor™ remote unit location system is known and is not described herein. Briefly, remote unit location logic 214 uses base station 106 and other fixed stations of known position which are in communication with base station 106 to determine an approximate physical location of mobile communications device 102.

In step 404, navigation server logic 216 (FIG. 2) calculates a magnetic bearing, i.e., a direction relative to magnetic North, and a range, i.e., distance to the destination. The mathematics involved in calculating bearing and distance from the location of mobile communications device 102 to the destination is straightforward and generally includes nothing more complex than simple trigonometry. While such mathematics are generally known, they are described briefly below for completeness. In step 406, navigation server logic 216 sends the magnetic bearing and range to mobile communications device 102.

In step 310 (FIG. 3), navigation logic 204 (FIG. 2) receives the magnetic bearing and range to the destination from base station 106. In an alternative embodiment, navigation logic 204 receives only location information pertaining to the location of mobile communications device 102 (FIG. 1) and calculates the magnetic bearing and range to the destination from the location of mobile communications device 102. This alternative embodiment requires additional processing resources within mobile communications device 102 to perform such calculations and requires determining of a location of the destination. In particular, if the destination is specified as a street address, mobile communications device 102 determines coordinates for the destination from the street address in this alternative embodiment. Such can be accomplished by receiving such destination coordinates from navigation server logic 216 (FIG. 2) in response to location polling in step 308 (FIG. 3) or during destination entering in step 304 if navigation logic 204 (FIG. 2) and navigation server logic 216 cooperate during destination entry in the manner described above. Alternatively, mobile communications device 102 can include sufficient data and logic to determine coordinates of the destination from an address or other location information known by the user. If the destination is mobile, e.g., another mobile communications device, remote unit location logic 214 determines the location of the mobile destination in generally the same manner that remote unit location logic 214 determines the location of mobile communications device 102 in step 402 (FIG. 4)and communicates the location of the mobile destination to navigation server logic 216 (FIG. 2).

Regardless, navigation logic 204 has a magnetic bearing and a range to the destination by completion of step 310 (FIG. 3) whether such bearing and range are determined by navigation logic 204 or navigation server logic 216. Loop step 312 and next step 320 define a loop in which steps 314-318 are performed for a predetermined period of time. The predetermined period of time is selected generally according to a number of factors which collectively determine how frequently the location of mobile communications device 102 (FIG. 1) should be updated. Such factors can include, for example, the accuracy of determination of the location of mobile communications determined by remote unit location logic 214 (FIG. 2), the precision with which range information is to be displayed to the user as described below, and the speed with which the user and mobile communications device could be moving. In one embodiment, the predetermined period of time is fifteen (15) seconds. In fifteen (15) seconds, a user of mobile communications device 102 can walk about seventy-five (75) feet which close approximates the accuracy of currently used locations technology in a typical multi-path radio environment at 1 GHz. In an alternative embodiment, the predetermined period of time is approximated by performing a predetermined number of iterations of the loop of steps 312-320 (FIG. 3). In addition, the predetermined period of time can be adjusted according to any of a number of factors including, for example, a level of service requested by the user, the speed with which the user (and thus mobile communications device 102) is moving, and the availability of processing and/or communications bandwidth of base station 106. The speed with which mobile communications device 102 is moving can be determined by compared determined locations of mobile communications device 102 at various times and calculating the rates at which the location of mobile communications device 102 changes.

In step 314, navigation logic 204 (FIG. 2) retrieves data representing a compass heading from a electronic compass 206 included within mobile communications device 102. In this illustrative embodiment, electronic compass 206 is the Vector 2X compass module available from Precision Navigation, Inc. of Santa Rosa, Calif. Generally, electronic compass 206 can be any type of compass which can be integrated with mobile communications device 102. Examples include magnetoresistive compasses such as those described in Application Note AN00022 by Philips Semiconductor of Eindhoven, the Netherlands entitled “Electronic Compass Design Using KMZ51 and KMZ52” and compasses using the Hall effect for orientation determination.

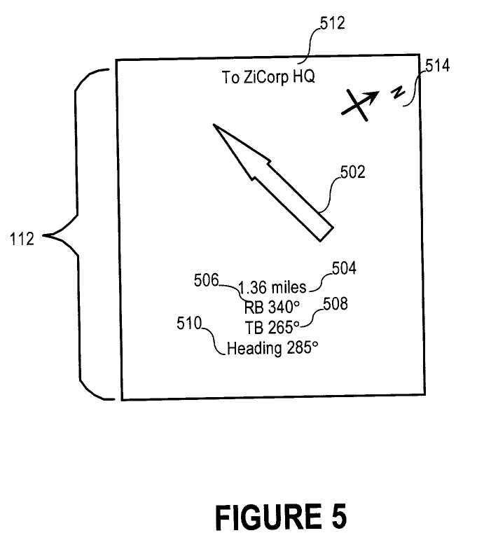

In step 316 (FIG. 3), navigation logic 204 (FIG. 2) calculates a relative bearing using the magnetic bearing received in step 310 (FIG. 3) and the compass heading received in step 314. In general, the relative bearing is the difference between the magnetic bearing and the compass heading. In particular, the relative bearing is the magnetic bearing less the compass heading and adjusted by an integer multiple of 360 degrees such that the relative bearing is between 0 and 359 degrees. In step 318 (FIG. 3), navigation logic 204 (FIG. 2) displays the relative bearing and range to the destination in display 112 as shown in FIG. 5.

In step 318 (FIG. 3), navigation logic 204 (FIG. 2) displays a pointer 502 (FIG. 5) in display 112. Pointer 502 is shown in the direction of the relative bearing to the destination calculated in step 314 (FIG. 3). Thus, pointer 502 (FIG. 5) points directly to the physical location of the destination entered by the user and therefore assists the user in traveling to the destination. Other useful navigation information is included in display 112 in step 318 (FIG. 3). For example, the range to the destination is displayed as text 504 (FIG. 5). The relative bearing is represented numerically in text 506. The magnetic bearing is represented numerically in text 508. The compass heading of mobile communications device 102 is represented numerically in text 510 and graphically by compass rose 514. In addition, the destination entered by the user is represented by text 512.

Of course, other types of informational displays can be used to aid navigation by the user according to the location and compass heading of mobile communications device 102. For example, a moving map can be displayed in display 112. Alternatively, progressive navigation instructions (such as “turn left at the intersection ahead of you—Kearny Ave.”) can be displayed to the user in display 112. In addition, the current position of mobile communications device 102 can be represented in latitude and longitude.

After step 318 (FIG. 3), processing transfers through next step 320 to loop step 312 in which steps 314-318 are repeated until the predetermined period of time has expired. Thus, a new compass heading is retrieved in step 314, a new relative bearing is calculated in step 316, and the new relative bearing is displayed in step 318. Thus, for the predetermined period of time, the display shown in FIG. 5 is continually updated in real time as the user turns toward pointer 502 to move toward the destination. The real-time reaction of pointer 502 to movement by the user assists the user tremendously in becoming oriented toward the destination. Of course, the range will not change, nor will the magnetic bearing, until an updated location of mobile communications device 102 (FIG. 1) is polled.

After the predetermined period of time has expired, processing transfers from loop step 312 (FIG. 3) through next step 322 to loop step 306 and steps 308-320 are repeated. Thus, a new location of mobile communications device 102 (FIG. 1) is determined in steps 308-310 (FIG. 3), and the navigation display of FIG. 5 is continually updated in the manner described above in steps 312-320 (FIG. 3). Since the new location of mobile communications device 102 (FIG. 1) is determined, the range as represented by text 504 (FIG. 5) and the magnetic bearing as represented by text 508 can change to show the user progress toward the destination.

Thus, mobile communications device 102 (FIG. 1) can provide navigation assistance similar to that provided by GPS systems at nominal additional cost. Although mobile communications device 102 is described above to include compass 206 (FIG. 2) and to use compass 206 to provide directional navigation assistance as described in conjunction with steps 312-320 (FIG. 3), significant navigation assistance can be provided without compass 206 (FIG. 2).

Without compass 206, steps 312-320 (FIG. 3) are replaced with a single display navigation step in which navigation data received from navigation server logic 216 (FIG. 2) is displayed to the user on display 112 (FIG. 1). Such navigation data can be as simple as a general direction such as North by Northwest (or “NNW”) displayed on display 112. Simple directional guidance as this can be very helpful to a user who (i) has a magnetic compass, (ii) has general directional awareness, or (iii) can deduce direction from her environment. For example, a user can identify North by noticing a direction of an increasing trend in numerical street addresses along a “North” street such as North First Street. Adding a range to the destination to display 112 improves navigational assistance provided by mobile communications device 102.

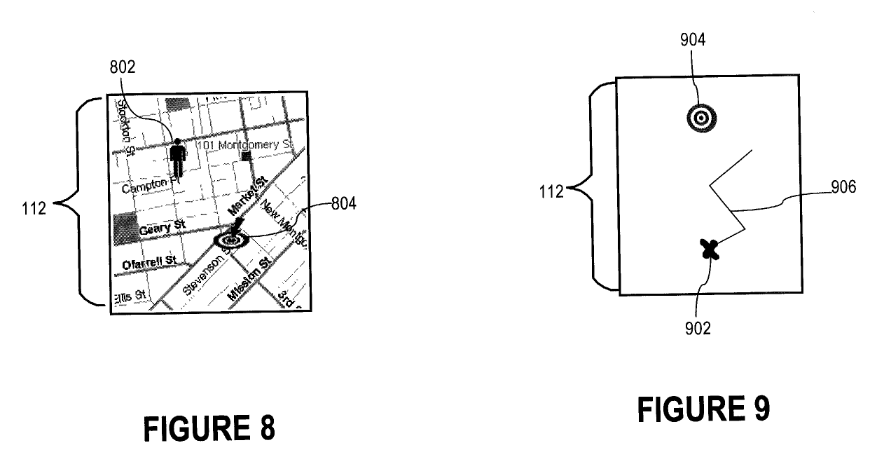

Navigation assistance provided by mobile communications device 102 without compass 206 (FIG. 2) can be even more sophisticated. For example, a vector from a previous position determined by remote unit location logic 214 to a current position can be used to estimate a directional orientation of mobile communications device 102. Other displays can provide quite helpful navigation data to the user without reliance upon directional orientation of mobile communications device 102 as shown in FIGS. 8 and 9.

FIG. 8 shows a display in which an icon 802 representing the current position of mobile communications device 102 as determined by remote unit location logic 214 (FIG. 2) superimposed over a map of the surrounding area. The display also includes an icon 804 (FIG. 8) representing the intended destination as specified by the user in the map of the display. As the user continues to move in an attempt to reach the destination, the position of icon 802 in the map of the display is updated. By noting changes in the position of icon 802 in relation to the position of icon 804, the user can very effectively navigate to the destination.

FIG. 9 shows a display in which an icon 902 represents the current position of mobile communications device 102 as determined by remote unit location logic 214 (FIG. 2). An icon 904 represents the intended destination. As the user, and therefore mobile communications device 102, moves in an attempt to reach the destination represented by icon 904, a path 906 is shown and updated in display 112. Path 906 is simple and yet is effective in representing to the user progress toward the destination and a relative direction (i.e., right or left) to which the user should continue in order to reach the destination.

Thus, even without compass 206 (FIG. 2), mobile communications device 102 and base station 106 cooperate to provide exception navigational guidance to a user at nominal additional cost.

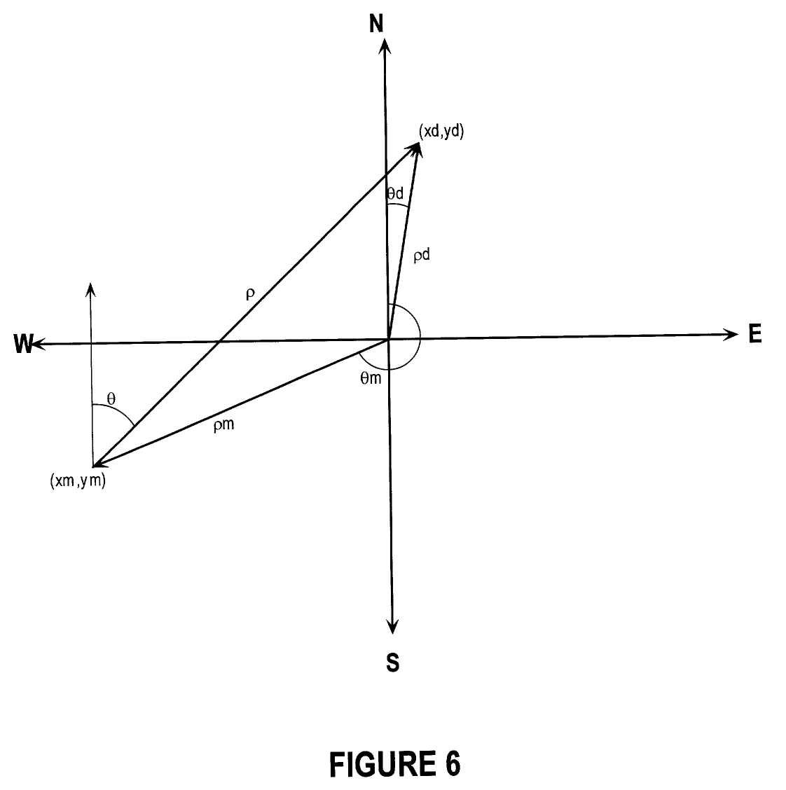

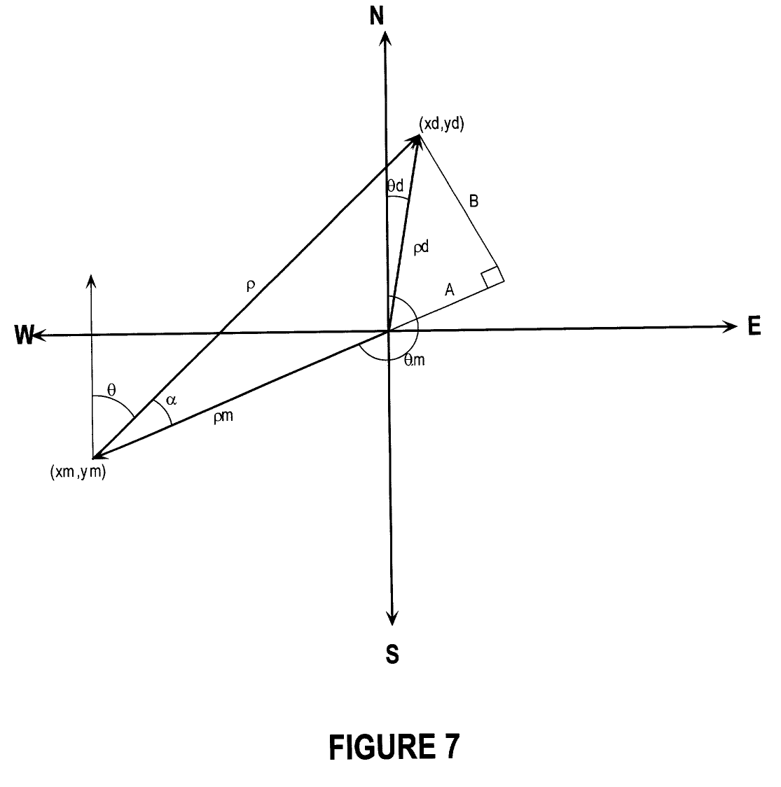

As described above, simple mathematics are used to calculate a relative bearing and range to the destination from the determined location of mobile communications device 102. FIG. 6 illustrates such calculation involving two-dimensional linear coordinates. FIG. 7 illustrates such calculation involving radial coordinates. Of course, it should be appreciated that determination of a direction and distance from mobile communications device 102 to the destination can be accomplished using a variety of known and conventional mathematical methods.

In both instances, the location of mobile communications device 102 as determined by remote unit location logic 214 (FIG. 2) is expressed in radial coordinates. In particular, in this illustrative embodiment, the location of mobile communications device 102 is expressed as (θₘ, ρₘ) where θₘ is the radial on which mobile communications device 102 is located relative to base station 106 expressed in degrees from magnetic north and ρₘ is the distance of mobile communications device 102 from base station 106. Similarly, the location of destination is expressed herein as (θ_{d}, ρ_{d}) where θ_{d} is the radial on which the destination is located relative to base station 106 expressed in degrees from magnetic north and ρ_{d} is the distance of the destination from base station 106. The desired information is expressed herein as (θ, ρ) where θ is the magnetic bearing from mobile communications device 102 to the destination expressed in degrees from magnetic North and ρ is the distance from mobile communications device 102 to the destination. While degrees are described herein as the units in which angles are expressed, it is appreciated and any unit of angular measurement can also be used. Measuring angles in degrees from magnetic North makes calculation of relative bearing for display to the user particularly straightforward.

In the embodiment illustrated by FIG. 6, radial coordinates of mobile communications device 102 and the destination are converted to two-dimensional linear coordinates, namely, (xₘ, yₘ) for the location of mobile communications device 102 and (y_{d}, x_{d}) for the location of the destination. The following equations are used to perform such a conversion:

xₘ=ρ sin θ

yₘ=ρ cos θ

Similar equations are used to convert the location of the destination to two-dimensional linear coordinates. The straight-line path from mobile communications device 102 to the destination is calculated as follows:

dx=x_{d}−xₘ

dy=y_{d}−yₘ

To present the user with a direction and distance, the relative bearing and range are calculated as follows:

ρ=\sqrt{dx²+dy²}

$$θ = arc tan ( \frac{ⅆ y}{ⅆ x} )$$

The approach illustrated in FIG. 6 has the advantage of working with few exceptions. One exception is when dx is zero. Simple logic resolves that problem, namely, the magnetic bearing is 360-degrees (magnetic North) if dy is positive and is 180-degrees (magnetic South) otherwise when dx is zero.

Since the precision of the magnetic bearing determined by navigation server logic 216 (FIG. 2) is effectively limited by the resolution of display 112 (FIG. 1) and by the relatively simple needs of a pedestrian navigating through a city, lookup tables can be used to significantly simplify the computation of trigonometric functions identified above. Generally, relative bearing accuracy within about plus or minus five (5) to ten (10) degrees is sufficient for pedestrian navigation.

Of course, the magnetic bearing and range can be determined using other coordinate systems such as a radial coordinate system as shown in FIG. 7. Distances A and B are determined according to the following equations:

A=ρ_{d} cos[180−(θ_{d}−θₘ)]

B=ρ_{d} sin[180−(θ_{d}−θₘ)]

To determine magnetic bearing and range, the angle is determined according to the following equation:

$$α = arc tan ( \frac{B}{{ρ}_{m} + A} )$$

The magnetic bearing and range are determined from α as follows:

θ=(180−θₘ)−α

$$ρ = \frac{B}{sin α}$$

As described above, the above equations use angles which are relative to magnetic North from base station 106. If base station 106 determines such angles relative to true North or some other reference angle, the angles are converted to magnetic headings using the magnetic deviation for the fixed location of base station 106.

The above description is illustrative only and is not limiting. Instead, the present invention is defined solely by the claims which follow and their full range of equivalents.

What is claimed is:

1. A method for providing navigational assistance to a user of a mobile communications device, the method comprising:
cooperating with at least one fixed base station to determine a geographical location of the mobile communications device;
sending data representing a destination;
receiving navigation data relative to the destination; and
representing the navigation data to the user.

2. The method of claim 1 wherein the navigation data includes a bearing to the destination.

3. The method of claim 1 wherein the navigation data includes a range to the destination.

4. The method of claim 1 wherein representing comprises:
deriving oriented navigation data according to an orientation of the mobile communications device; and
representing the oriented navigation data to the user.

5. The method of claim 4 wherein the oriented navigation data includes a relative bearing to the destination wherein the relative bearing is relative to an orientation of the mobile communications device.

6. The method of claim 5 wherein the relative bearing is relative to a directional orientation of the mobile communications device.

7. The method of claim 4 where deriving comprises:
determining a compass heading of the mobile communications device; and
forming the oriented navigation data from the navigation data according to the compass heading.

8. A mobile communications device which provides navigational assistance to a user, the device comprising:
a user interface module;
a data communication module which is capable of sending data to and receiving data from at least one fixed base station;
a navigation module which is operatively coupled to the user interface module, and the data communication module and which, when activated by the user:
receives from the user interface module destination data representing a destination;
causes the data communication module to communicate the destination data to the at least one fixed base station;
causes the data communication module to cooperate with the at least one fixed base station to determine a geographical location of the mobile communications device;
receives, from the data communication module, navigation data relative to the destination; and
causes the user interface module to represent the navigation data to the user.

9. The mobile communications device of claim 8 wherein the navigation data comprises a bearing to the destination.

10. The mobile communications device of claim 8 wherein the navigation data comprises a range to the destination.

11. The mobile communications device of claim 8 further comprising:
an orientation measuring device which is operatively coupled to the navigation module;
wherein the navigation module, when activated by the user, also derives oriented navigation data from the navigation data according to an orientation determined by the orientation measuring device; and
further wherein the navigation module causes the user interface module to represent the navigation data to the user by causing the user interface module to represent the oriented navigation data to the user.

12. The mobile communications device of claim 11 wherein the orientation measuring device is a compass.

13. The mobile communications device of claim 11 wherein the oriented navigation data includes a relative bearing to the destination wherein the relative bearing is relative to an orientation of the mobile communications device.

14. The mobile communications device of claim 11 wherein the oriented navigation data includes a relative bearing to the destination wherein the relative bearing is relative to a directional orientation of the mobile communications device.

15. A method for providing navigation assistance to a user of a mobile communications device, the method comprising:
determining a location of the mobile communications device; and
sending navigation data representing the location to the mobile communications device.

16. The method of claim 15 further comprising:
receiving data representing a destination of the mobile communications device;
wherein the navigation data specifies a relationship between the location and the destination.

17. The method of claim 16 wherein the navigation data includes a bearing to the destination.

18. The method of claim 16 wherein the navigation data includes a range to the destination.

19. A base station for communications through a mobile communications device, the base station comprising:
a communications module which is capable of conducting communications with the mobile communications device;
a mobile device location module which is operatively coupled to the communications module and which is capable of determining a location of the mobile communications device; and
a mobile device navigation module which is operatively coupled to the communications module and the mobile device location module and which can assist navigation of the mobile communications module by:
causing the mobile device location module to determine a current location of the mobile communications device; and
causing the communications module to send navigation data representing the current location to the mobile communications device.

20. The base station of claim 19 wherein the mobile device navigation module can assist navigation of the mobile communications device by also:
receiving data, through the communications module, which represents a destination;
wherein the navigation data represents a relationship between the current location of the mobile communications device and the destination.

21. The base station of claim 20 wherein the navigation data includes a bearing to the destination.

22. The base station of claim 20 wherein the navigation data includes a range to the destination.
